(19) United States
(12) Patent Application Publication
(10) Pub. No.: US 2022/0334780 A1
(43) Pub. Date: Oct. 20, 2022

(54) IMAGE FORMING APPARATUS, CONTROL METHOD OF IMAGE FORMING APPARATUS, AND INSTRUCTIONS OF IMAGE FORMING APPARATUS

(71) Applicant: Konica Minolta, Inc., Tokyo (JP)

(72) Inventor: Masayuki Yasukaga, Tokyo (JP)

(73) Assignee: Konica Minolta, Inc., Tokyo (JP)

(21) Appl. No.: 17/721,740

(22) Filed: Apr. 15, 2022

(30) Foreign Application Priority Data
Apr. 19, 2021 (JP) 2021-070123

(51) Int. Cl. G06F 3/12; H04N 1/44; H04L 9/32; H04L 9/08

(52) U.S. Cl. CPC G06F 3/1222; G06F 3/1238; H04N 1/4426; H04L 9/321; H04L 9/0894

(57) ABSTRACT

An image forming apparatus includes: a storage that stores a job that is encrypted; and a hardware processor that: decrypts the encrypted job read from the storage, executes the decrypted job, upon detecting a cyberattack during execution of the decrypted job, identifies a target of the cyberattack, and switches an operation related to the decrypted job being executed based on the target.

### CROSS-REFERENCE TO RELATED APPLICATIONS

The present application claims priority from Japanese patent Application No. 2021-070123, filed on Apr. 19, 2021, the contents of which are incorporated herein by reference in its entirety.

### BACKGROUND

### Technological Field

The present disclosure relates to an image forming apparatus, and more specifically, to security of an image forming apparatus.

### Description of the Related Art

In recent years, many image forming apparatuses such as multifunction peripherals (MFPs) are connected to a network. These image forming apparatuses may be hit by a cyberattack such as a distributed denial of service attack (DDoS attack) or a password list attack through a network. Even if image data, authentication information, and the like in an image forming apparatus are encrypted, the encrypted data may be leaked by stealing an encryption key. For this reason, there is a need for a technology for coping with a cyberattack or unauthorized access.

Regarding a technique for coping with unauthorized access, for example, JP 2006-094068 A discloses an image processing apparatus that “when unauthorized access is detected, when encrypted data stored in a user data storage area is erased, and when an instruction to change an encryption key is accepted from an administrator, erases an encryption key stored in an encryption key storage unit to generate a new encryption key (second encryption key), stores, the generated encryption key in the encryption key storage unit, and sets a flag indicating the type of encryption key to “2”” (see [Abstract]).

According to the technique disclosed in JP 2006-094068 A, there is a possibility that a job being executed is forcibly interrupted by erasing an encryption key. Accordingly, there is a need for a technology capable of switching an operation related to a job being executed according to the target of a cyberattack, instead of forcibly terminating the job being executed at all times on the basis of detection of the cyberattack.

### SUMMARY

One or more embodiments of the invention provide a technology for switching an operation related to a job being executed according to the target of a cyberattack.

According to one or more embodiments, an image forming apparatus comprises: a storage that stores an encrypted job; and a hardware processor that executes the encrypted job, wherein the hardware processor decrypts the encrypted job read from the storage, executes the decrypted job, on the basis of detection of a cyberattack during execution of the decrypted job, identifies a target of the cyberattack, and on the basis of the target of the cyberattack, switches an operation related to the job being executed.

### BRIEF DESCRIPTION OF THE DRAWINGS

The objects, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an image forming apparatus according to one or more embodiments;

FIG. 2 is a diagram illustrating an example of a hardware configuration of the image forming apparatus according to one or more embodiments;

FIG. 3 is a diagram illustrating an example of a functional configuration of the image forming apparatus according to one or more embodiments; and

FIG. 4 is a flowchart illustrating an example of processing executed by the image forming apparatus according to one or more embodiments.

### DETAILED DESCRIPTION

Hereinafter, embodiments of the present invention will be described with reference to the drawings. However, the scope of the invention is not limited to the disclosed embodiments. In the following description, the same components are denoted by the same reference numerals. Their names and functions are the same. Accordingly, detailed descriptions thereof will not be repeated.

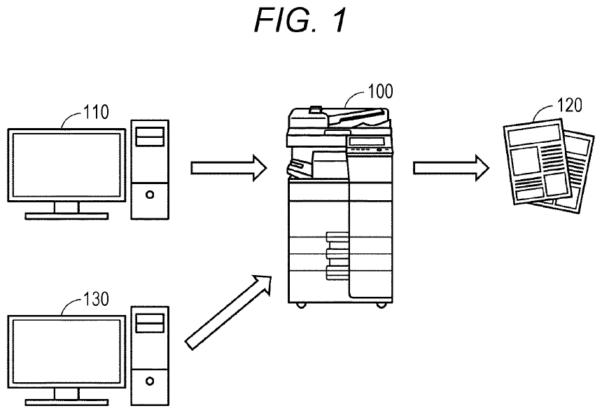

FIG. 1 is a diagram illustrating an example of an image forming apparatus 100 according to one or more embodiments. An example of a basic function of the image forming apparatus 100 and a function against a cyberattack will be described with reference to FIG. 1.

(a. Basic Function of Image Forming Apparatus 100)

The image forming apparatus 100 according to one or more embodiments is connected to a terminal 110 of a user through a network. As an example, the image forming apparatus 100 has a user authentication function and a function of executing a job. A job may include, as an example, a print command, image data (text data) to be printed, and the like.

First, the “user authentication function” will be described. The image forming apparatus 100 uses user authentication information to carry out the user authentication function. “User authentication information” is an identifier, a password, and the like of the user.

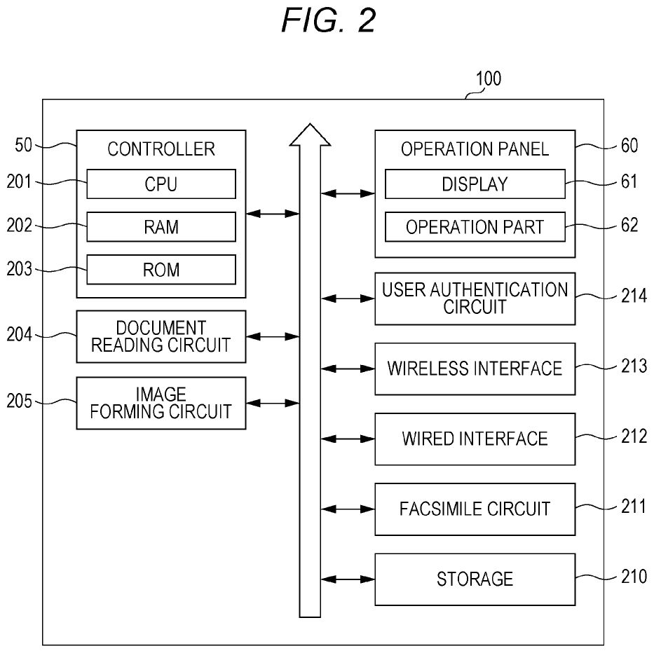

First, the image forming apparatus 100 acquires user authentication information (identifier, password, and the like of user) through an operation panel 60 (see FIG. 2) of the image forming apparatus 100 or a network.

Next, the image forming apparatus 100 refers to a list of user authentication information stored in a storage 210 (see FIG. 2), and determines whether or not there is user authentication information matching the acquired user authentication information in the list of user authentication information.

Next, the image forming apparatus 100 permits the user to use functions of the image forming apparatus 100 on the basis of determining that there is user authentication information matching the acquired user authentication information (on the basis of successful authentication processing). In a case where the image forming apparatus 100 has acquired the user authentication information through the network, the image forming apparatus 100 provides the functions of the image forming apparatus 100 to the terminal 110 that transmitted the user authentication information.

Next, the “job execution function” will be described. The image forming apparatus 100 uses an encryption key (secret encryption key) to carry out the job execution function. An “encryption key” is data used for processing of encrypting and decrypting data.

First, the image forming apparatus 100 acquires a job (job execution request) such as a print job from the terminal 110 that has completed the user authentication processing. In one aspect, the image forming apparatus 100 may receive a job from the operation panel 60.

Next, the image forming apparatus 100 encrypts the acquired job using the encryption key stored in a RAM 202. Then, the image forming apparatus 100 temporarily stores the encrypted job in the random access memory (RAM) 202 (see FIG. 2). The image forming apparatus 100 can generate an encryption key on the basis of data for generating an encryption key stored in the storage 210 or the like at a timing such as startup, and store the encryption key in the RAM 202.

Next, the image forming apparatus 100 decrypts the encrypted job stored in the RAM 202 using the encryption key. Then, the image forming apparatus 100 executes the decrypted job. The job here includes, for example, printing processing using an image forming circuit 205 (see FIG. 2) and the like. The image forming apparatus 100 can output printed matter 120 by executing a job, for example.

(b. Function Against Cyberattack of Image Forming Apparatus 100)

As described above, user authentication information and an encryption key are stored inside the image forming apparatus 100. These are very important data, and are also data that is likely to be a target of a cyberattack. Additionally, the image forming apparatus 100 could be connected to a malicious third party terminal 130 in addition to the terminal 110 of the authorized user. For this reason, as described below, the image forming apparatus 100 according to one or more embodiments has a function for protecting data in the image forming apparatus 100 such as user authentication information and an encryption key from a cyberattack.

The image forming apparatus 100 mainly includes a function of identifying the target of a cyberattack, a first function against a cyberattack, and a second function against a cyberattack as functions for protecting data in the image forming apparatus 100 from a cyberattack.

First, the “function of identifying the target of a cyberattack” will be described. When detecting a cyberattack (unauthorized access) from the malicious third party terminal 130, the image forming apparatus 100 identifies the target of the cyberattack from information such as the received packet and the reception port. The target of a cyberattack includes, as an example, data on the RAM 202 and user authentication information. The data on the RAM 202 is data temporarily expanded on the RAM 202 and also includes an encryption key.

In one aspect, the image forming apparatus 100 may first identify the type of the cyberattack. The type of a cyberattack may include, for example, a buffer overflow attack, a port scan attack, a password list attack, and the like. The image forming apparatus 100 can determine the target of the cyberattack on the basis of the type of the cyberattack. For this reason, it can be said that the function of identifying the target of the cyberattack is a function of identifying the type of the cyberattack. As an example, there is a high possibility that a buffer overflow attack, a port scan attack, and the like are cyberattacks on data (encryption keys and the like) on the RAM 202. As another example, there is a high possibility that a password list attack that tries to execute authentication processing continuously is a cyberattack on user authentication information.

The image forming apparatus 100 identifies the target of the cyberattack (identifies type of cyberattack), and uses the following first function against a cyberattack and second function against a cyberattack properly on the basis of the target of the cyberattack.

Next, the “first function against a cyberattack” will be described. The first function against a cyberattack is to erase the encryption key on the RAM 202. As described above, all the data on the RAM 202 is encrypted. For this reason, even if a malicious third party steals the encrypted data, the encrypted data cannot be decrypted. Note, however, that in a case where a malicious third party steals the encryption key, the malicious third party can decrypt all the data on the RAM 202. For this reason, the image forming apparatus 100 erases the encryption key on the RAM 202 on the basis of the determination that the detected cyberattack targets the data (encryption key) on the RAM 202.

However, in a case where the encryption key is deleted while the image forming apparatus 100 is executing a job, the job being executed is interrupted. This is because the image forming apparatus 100 executes a job while gradually decrypting the encrypted job on the RAM 202, and if the encryption key is deleted during the execution of the job, the image forming apparatus 100 cannot decrypt the unprocessed encrypted job.

Hence, the image forming apparatus 100 changes the operation of the first function against a cyberattack according to the state of the job being executed. Specifically, in a case where a cyberattack targeting data on the RAM 202 is detected, the image forming apparatus 100 estimates the scheduled completion time of the job when there is a job being executed.

When the scheduled completion time of the job being executed is within a predetermined time (e.g., within one minute or the like after detection of cyberattack), the image forming apparatus 100 waits for completion of the job being executed and then erases the encryption key on the RAM 202.

Conversely, when the scheduled completion time of the job being executed exceeds a predetermined time, the image forming apparatus 100 stops the job being executed (does not wait for completion of job being executed), and erases the encryption key on the RAM 202. Moreover, in a case where a cyberattack targeting data on the RAM 202 is detected, the image forming apparatus 100 immediately erases the encryption key on the RAM 202 when a job is not executed or when a job being executed is completed.

As described above, the image forming apparatus 100 can change the encryption key deletion timing on the basis of the scheduled completion time of the job. It is known that acquisition of an encryption key using memory leakage or the like takes a certain time or more. Hence, when there is a job estimated to be completed before a malicious third party steals the encryption key, the image forming apparatus 100 erases the encryption key after waiting for completion of the job. With this configuration, the image forming apparatus 100 can prevent data theft without wasting a job being executed.

Further, the “second function against a cyberattack” will be described. The second function against a cyberattack is a function of stopping user authentication function via network. In one aspect, a user authentication function may include an authentication function of a terminal or another device.

More specifically, in a case where a cyberattack targeting user authentication information is detected, the image forming apparatus 100 stops the user authentication function via network. At that time, when there is a job being executed, the image forming apparatus 100 continues the execution of the job without deleting the encryption key on the RAM 202.

This is because a cyberattack targeting user authentication information such as a password list attack does not target data on the RAM 202 such as the encryption key. Hence, in order to maintain user convenience, the image forming apparatus 100 stops the user authentication function via network without stopping the job being executed.

In one aspect, the image forming apparatus 100 may execute only one or both of the first function against a cyberattack and the second function against a cyberattack on the basis of the detected type of the cyberattack. The image forming apparatus 100 can use the first function and the second function to switch an operation related to a job being executed (whether or not to stop execution of job, whether or not to delete encryption key, determination of deletion timing of encryption key, and the like).

Additionally, in another aspect, after executing one or both of the first function against a cyberattack and the second function against a cyberattack, the image forming apparatus 100 may be restarted (image forming apparatus 100 may be powered on again after being powered off) in order to return to the normal state.

FIG. 2 is a diagram illustrating an example of a hardware configuration of the image forming apparatus 100 according to one or more embodiments. A circuit configuration of the image forming apparatus 100 according to the one or more embodiments will be described with reference to FIG. 2. The image forming apparatus 100 includes a controller 50, a document reading circuit 204, the image forming circuit 205, the storage 210, a facsimile circuit 211, a wired interface 212, a wireless interface 213, a user authentication circuit 214, and the operation panel 60.

The controller 50 includes a central processing unit (CPU) 201, the RAM 202, and a read only memory (ROM) 203.

The CPU 201 executes or refers to various instructions and data read into the RAM 202. In one aspect, the CPU 201 may be a built-in CPU, a field programmable gate array (FPGA), or a combination thereof. The CPU 201 can execute instructions for implementing various functions of the image forming apparatus 100.

The RAM 202 stores instructions executed by the CPU 201 and data referred to by the CPU 201. In one aspect, a dynamic random access memory (DRAM) or a static random access memory (SRAM) may be used as the RAM 202.

The ROM 203 is a nonvolatile memory, and may store instructions executed by the CPU 201. In that case, the CPU 201 executes the instructions read from the ROM 203 to the RAM 202. In one aspect, an erasable programmable read only memory (EPROM), an electrically erasable programmable read only memory (EEPROM), or a flash memory may be used as the ROM 203.

The document reading circuit 204 can convert a document (text, graph, picture, combination thereof, and the like) scanned by the image forming apparatus 100 into image data. The CPU 201 can acquire image data through the document reading circuit 204. In one aspect, the document reading circuit 204 can store image data in the storage 210. In another aspect, the document reading circuit 204 may acquire image data through the wired interface 212 and store the acquired image data in the storage 210.

The image forming circuit 205 performs printing processing of image data captured by the image forming apparatus 100. In one aspect, the image forming circuit 205 may include a circuit that controls various actuators for a printing function including an imaging unit, a fixing unit, and the like.

The storage 210 is a nonvolatile memory, and can store data even in a state where the power supply of the image forming apparatus 100 is turned off. The storage 210 may store any instructions and data executed or referred to by the CPU 201.

Additionally, the storage 210 can store data for generating an encryption key. The CPU 201 can generate an encryption key using the data for generating the encryption key at a timing such as startup of the image forming apparatus 100. The CPU 201 places the generated encryption key on the RAM 202. In one aspect, the encryption key may be stored in a flash memory or the like different from the storage 210.

Moreover, the storage 210 can store a list of user authentication information (identifier, password, and the like of user) used in user authentication processing. The list of user authentication information can be stored in the storage 210 as a table of a relational database or in any format. The CPU 201 or the user authentication circuit 214 can refer to a list of user authentication information on the basis of acceptance of an authentication request from the user.

In one aspect, a hard disk drive (HDD) or a solid state drive (SSD) may be used as the storage 210. The CPU 201 can read various instructions from the storage 210 to the RAM 202 as necessary and execute the read instructions.

The facsimile circuit 211 transmits and receives a document or image data by facsimile using a telephone line. In one aspect, a circuit having a communication control function of a facsimile and a communication port of a telephone line may be used as the facsimile circuit 211.

The wired interface 212 is connected to a wired network device. In one aspect, a wired local area network (LAN) port may be used as the wired interface 212. The wireless interface 213 is connected to a wireless network device. In one aspect, a Wi-Fi (registered trademark) module or the like may be used as the wireless interface 213. The wired interface 212 and the wireless interface 213 can transmit and receive data using a communication protocol such as transmission control protocol/Internet protocol (TCP/IP) or user datagram protocol (UDP).

The user authentication circuit 214 performs authentication processing of a user who uses the image forming apparatus 100. The user authentication circuit 214 can cooperate with an external authentication server, or not cooperate with an external authentication server. In one aspect, the controller 50 may have the function of the user authentication circuit 214.

The operation panel 60 includes a display 61 and an operation part 62. The display 61 includes a liquid crystal monitor, an organic electro luminescence (EL) monitor, or the like. The liquid crystal monitor, the organic EL monitor, or the like includes a touch sensor, and can display an operation menu and accept an input by a user's touch. The operation part 62 includes a plurality of buttons and can accept an input from the user similarly to the touch panel. In one aspect, the operation part 62 may include a touch sensor superimposed on the display 61.

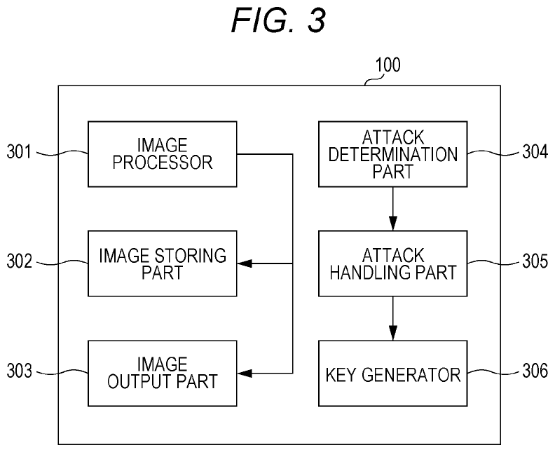

FIG. 3 is a diagram illustrating an example of a functional configuration of the image forming apparatus 100 according to one or more embodiments. Each function of the image forming apparatus 100 illustrated in FIG. 3 may be implemented as instructions executed on the hardware illustrated in FIG. 2, or may be implemented as hardware.

The image forming apparatus 100 includes, as a main functional configuration, an image processor 301, an image storing part 302, an image output part 303, an attack determination part 304, an attack handling part 305, and a key generator 306.

The image processor 301 executes conversion processing and print processing of a job (including image data) acquired by the image forming apparatus 100. More specifically, the image processor 301 encrypts the job acquired by the image forming apparatus 100. Additionally, the image processor 301 decrypts an encrypted job and executes print processing. The image processor 301 controls the image forming circuit 205 at the time of executing print processing.

The image storing part 302 stores the job encrypted by the image processor 301 in the storage 210. In one aspect, the image storing part 302 may execute job encryption processing and decryption processing in place of the image processor 301.

The image output part 303 transmits (outputs) image data to the terminal 110, a storage server, or the like through the network. The image output part 303 can transmit image data through the wired interface 212 or the wireless interface 213.

The attack determination part 304 can detect that the image forming apparatus 100 is being hit by a cyberattack and determine the target of the cyberattack. The attack determination part 304 can at least determine whether the cyberattack hitting the image forming apparatus 100 is targeting data (encryption key or the like) on the RAM 202 or targeting user authentication information. In one aspect, the attack determination part 304 may first identify the type of the cyberattack. The attack determination part 304 can determine the target of the cyberattack from the type of the cyberattack.

The attack handling part 305 executes processing corresponding to the cyberattack according to the target of the cyberattack hitting the image forming apparatus 100. In a case where the cyberattack hitting the image forming apparatus 100 is targeting data (encryption key or the like) on the RAM 202, the attack handling part 305 erases the encryption key on the RAM 202. As described with reference to FIG. 1, the encryption key deletion timing changes on the basis of the job execution state.

Additionally, in a case where the cyberattack hitting the image forming apparatus 100 is targeting user authentication information, the attack handling part 305 stops the function of user authentication processing via network. At that time, the attack handling part 305 may omit the encryption key deletion processing and the job interruption processing.

In one aspect, the attack handling part 305 may return the image forming apparatus 100 to the normal operation mode by restarting the image forming apparatus 100 after executing the processing corresponding to the cyberattack.

The key generator 306 generates an encryption key on the basis of data for generating an encryption key in the storage 210. As an example, the key generator 306 can generate an encryption key at a timing when the image forming apparatus 100 is powered on or a timing after the image forming apparatus 100 is restarted.

In one aspect, the CPU 201 may execute, as instructions, the image processor 301, the image storing part 302, and the image output part 303 in parallel with the attack determination part 304, the attack handling part 305, and the key generator 306.

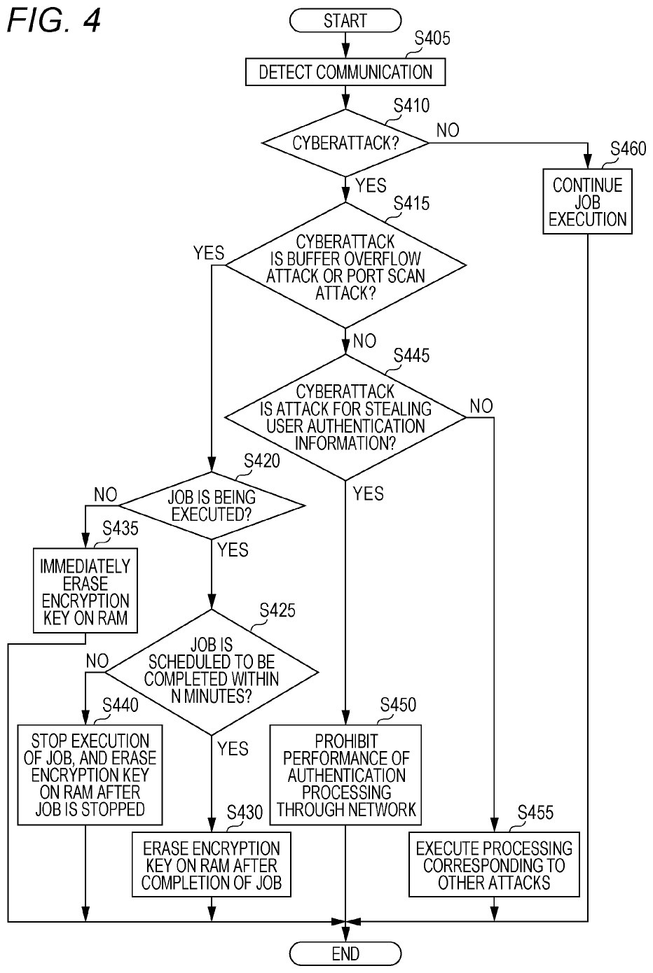

FIG. 4 is a flowchart illustrating an example of processing executed by the image forming apparatus 100 according to one or more embodiments. In one aspect, the CPU 201 may read instructions for performing the processing of FIG. 4 from the storage 210 or the ROM 203 into the RAM 202 and execute the instructions. In another aspect, a part or all of the processing can be implemented as a combination of circuit elements configured to execute the processing.

In step S405, the CPU 201 detects communication with the image forming apparatus 100. In step S410, the CPU 201 determines whether or not the image forming apparatus 100 is being hit by a cyberattack. If the CPU 201 determines that the image forming apparatus 100 is being hit by a cyberattack (YES in step S410), the control proceeds to step S415. If not (NO in step S410), the CPU 201 proceeds with the control to step S460.

In step S415, the CPU 201 determines whether or not the cyberattack is a buffer overflow attack or a port scan attack (whether or not cyberattack is attack targeting data on RAM 202). If the CPU 201 determines that the cyberattack is a buffer overflow attack or a port scan attack (YES in step S415), the control proceeds to step S420. If not (NO in step S415), the CPU 201 proceeds with the control to step S445.

In step S420, the CPU 201 determines whether or not the image forming apparatus 100 is executing a job. If the CPU 201 determines that the image forming apparatus 100 is executing a job (YES in step S420), the control proceeds to step S425. If not (NO in step S420), the CPU 201 proceeds with the control to step S435.

In step S425, the CPU 201 determines whether or not the job being executed is scheduled to be completed within N minutes (predetermined arbitrary time). If the CPU 201 determines that the job being executed is scheduled to be completed within N minutes (YES in step S425), the control proceeds to step S430. If not (NO in step S425), the CPU 201 proceeds with the control to step S440.

In step S430, the CPU 201 erases the encryption key on the RAM 202 after completion of the job. In step S435, the CPU 201 erases the encryption key on the RAM 202 immediately. For example, the CPU 201 can execute the processing of this step in a case where the job is completed immediately after it is determined that the image forming apparatus 100 is being hit by a cyberattack targeting the encryption key, or the like. In step S440, the CPU 201 stops execution of the job and erases the encryption key on the RAM 202 after the job is stopped.

In step S445, the CPU 201 determines whether or not the cyberattack is an attack for stealing user authentication information. If the CPU 201 determines that the cyberattack is an attack for stealing user authentication information (YES in step S445), the control proceeds to step S450. If not (NO in step S445), the CPU 201 proceeds with the control to step S455. In step S450, the CPU 201 prohibits the image forming apparatus 100 from performing the authentication processing via network. In step S455, the CPU 201 executes processing (notification processing to administrator, and the like) corresponding to other attacks (cyberattacks targeting information other than encryption key and user authentication information). In step S460, the CPU 201 continues the execution of the job.

As described above, the image forming apparatus 100 according to one or more embodiments switches the operation related to the job according to the type of the cyberattack.

In one aspect, in a case where the image forming apparatus 100 is hit by a cyberattack targeting data (encryption key) on the RAM 202, on the basis of the fact that the scheduled completion time of the job is within a predetermined time, the image forming apparatus 100 waits for completion of the job and then erases the encryption key. As a result, the image forming apparatus 100 can prevent leakage of data such as an encryption key due to a cyberattack, without wasting a job being executed.

Additionally, in another aspect, in a case where the image forming apparatus 100 is hit by a cyberattack targeting data (encryption key) on the RAM 202, on the basis of the fact that the scheduled completion time of the job exceeds a predetermined time, the image forming apparatus 100 executes job stop processing and erases the encryption key. As a result, the image forming apparatus 100 can prevent leakage of data such as an encryption key due to a cyberattack.

Additionally, in another aspect, in a case where the image forming apparatus 100 is hit by a cyberattack targeting data (encryption key) on the RAM 202, on the basis of the fact that the job is completed or not being executed, the image forming apparatus 100 immediately erases the encryption key. As a result, the image forming apparatus 100 can prevent leakage of data such as an encryption key due to a cyberattack.

Moreover, in another aspect, in a case where the image forming apparatus 100 is hit by a cyberattack targeting user authentication information, the image forming apparatus 100 stops the function of user authentication processing via network without stopping the job being executed (without erasing encryption key). As a result, the image forming apparatus 100 can prevent leakage of user authentication information due to a cyberattack without wasting a job being executed.

Although embodiments of the present invention have been described and illustrated in detail, the disclosed embodiments are made for purposes of illustration and example only and not limitation. The scope of the present invention should be interpreted not by terms of the above description but by terms of the appended claims, and is intended to include all modifications within the meaning and scope equivalent to the claims. Additionally, the disclosed contents described in the embodiments and the modifications are intended to be implemented alone or in combination wherever possible.

What is claimed is:

1. An image forming apparatus comprising:
a storage that stores a job that is encrypted; and
a hardware processor that:
decrypts the encrypted job read from the storage,
executes the decrypted job,
upon detecting a cyberattack during execution of the decrypted job, identifies a target of the cyberattack, and
switches an operation related to the decrypted job being executed based on the target.

2. The image forming apparatus according to claim 1, wherein
the hardware processor:
identifies that the target is an encryption key, and
identifies that the target is user authentication information.

3. The image forming apparatus according to claim 2, wherein in response to identifying that the target is the user authentication information, the hardware processor continues execution of the decrypted job and stops a user authentication function via network.

4. The image forming apparatus according to claim 2, wherein in response to identifying that the target is the encryption key, the hardware processor erases the encryption key.

5. The image forming apparatus according to claim 4, wherein upon detecting that the decrypted job being executed is completed within a predetermined time, the hardware processor erases the encryption key after execution of the decrypted job.

6. The image forming apparatus according to claim 4, wherein upon detecting that the decrypted job being executed is not completed within a predetermined time, the hardware processor interrupts execution of the decrypted job and erases the encryption key.

7. The image forming apparatus according to claim 4, wherein upon detecting that the decrypted job is not being executed, the hardware processor erases the encryption key.

8. A control method of an image forming apparatus, the control method comprising:
encrypting and temporarily storing a job that is input;
decrypting the encrypted job;
executing the decrypted job;
upon detecting of a cyberattack during execution of the decrypted job, identifying a target of the cyberattack; and
switching an operation related to the decrypted job being executed based on the target.

9. The control method according to claim 8, wherein
the identifying the target comprises:
identifying that the target is an encryption key, and
identifying that the target is user authentication information.

10. The control method according to claim 9 further comprising, in response to identifying that the target is the user authentication information, continuing execution of the decrypted job and stopping a user authentication function via network.

11. The control method according to claim 9 further comprising, in response to identifying that the target is the encryption key, erasing the encryption key.

12. The control method according to claim 11, wherein the erasing the encryption key comprises, upon detecting that the decrypted job being executed is completed within a predetermined time, erasing the encryption key after execution of the decrypted job.

13. The control method according to claim 11, wherein the erasing the encryption key comprises, upon detecting that the decrypted job being executed is not completed within a predetermined time, interrupting execution of the decrypted job and erasing the encryption key.

14. The control method according to claim 11, wherein the erasing the encryption key comprises, upon detecting that the decrypted job is not being executed, erasing the encryption key.

15. A non-transitory recording medium storing a computer readable instructions for causing one or more processors to execute the control method according to claim 8.
